(19) United States
(12) Patent Application Publication
(10) Pub. No.: US 2026/0146460 A1
(43) Pub. Date: May 28, 2026

(54) SUSPENDABLE CONVEYOR TROLLEY FOR FAÇADE ELEMENTS FOR HIGH-RISE BUILDINGS AND RELATED SYSTEMS

(71) Applicant: BRUNKEBERG SYSTEMS AB, Stockholm (SE)

(72) Inventor: Henrik FALK, Stockholm (SE)

(21) Appl. No.: 19/117,162

(22) PCT Filed: Sep. 27, 2023
(86) PCT No.: PCT/EP2023/076783

§ 371 Date: Mar. 31, 2025

(30) Foreign Application Priority Data
Oct. 3, 2022 (SE) 2230318-4

(51) Int. Cl. E04G 21/16; B66C 1/62; E04G 23/02

(52) U.S. Cl. CPC E04G 21/167; B66C 1/62; E04G 23/0296

(57) ABSTRACT

A suspendable conveyor trolley (300) for horizontally conveying a façade element (230) along a façade of a high-rise building (200) is disclosed. The trolley (300) comprises a trolley elongated element (310) adapted to engage with a façade lifting elongated element (235) adapted to be attached to the façade element (230), to carry and convey the façade element (230) along the façade. The trolley elongated element (310) comprises a trolley hook portion (320), having a hook shaped cross-section and being adapted to receive a lifting hook portion (236) of the façade lifting elongated element (235). Moreover, the trolley (300) comprises a movable locking member (330) that is movably attached to the trolley elongated element (310) and mechanically biased towards a locking position (P1), in which the trolley hook portion (320) is blocked by the movable locking member (330). Furthermore, the movable locking member (330) is adapted to be moved by a lifting jig (500) away from the locking position (P1) when the lifting jig (500) reaches and engages with the façade lifting elongated element (235). A related system (700) comprising the trolley (300) and the lifting jig are also disclosed.

### TECHNICAL FIELD

The embodiments herein relate to the field of façade installations on high-rise buildings, such as skyscrapers, multi-storey buildings or the like. In particular, a suspendable conveyor trolley for horizontally conveying a façade element along a façade of a high-rise building and a system related thereto are disclosed.

### BACKGROUND

Construction and repair of high-rise buildings includes various transportation means and procedures, which usually differ from one manufacturer of a façade system to another. One process for construction of a high-rise building is described in e.g. “A Novel Façade System to Improve the Whole High-Rise Building Process” by Henrik Falk et al, published in 2016. Within this process the façade elements are transported horizontally to a position at a ground level of the building and then hoisted vertically to a desired floor for installation. EP3283427 discloses a façade installation of this kind.

When handling heavy objects, such as façade elements, safety is a major concern. In case a façade element would fall off its carrying structure, severe human casualties and material damages, both cost and/or time wise, may occur. A problem is thus how to improve safety in a façade element transport system of the aforementioned kind.

### SUMMARY

An object of the current invention is to mitigate, or even eliminate, the abovementioned problem, or other problems or disadvantages.

According to an aspect, this object is achieved by a suspendable conveyor trolley for horizontally conveying a façade element along a façade of a high-rise building. The suspendable conveyor trolley is adapted to be suspended on a guide rail that runs horizontally along the façade. The suspendable conveyor trolley comprises a trolley elongated element adapted to engage with a façade lifting elongated element adapted to be attached to the façade element, to carry and convey the façade element along the façade.

The trolley elongated element comprises a trolley hook portion, having a hook shaped cross-section and being adapted to receive a lifting hook portion of the façade lifting elongated element. Furthermore, the suspendable conveyor trolley comprises a movable locking member that is movably attached to the trolley elongated element and mechanically biased towards a locking position, in which the trolley hook portion is blocked by the movable locking member. The movable locking member is adapted to be moved by a lifting jig away from the locking position when the lifting jig reaches and engages with the façade lifting elongated element.

In this manner, the biased movable locking member blocks unintended and/or undesired removal/release of the façade lifting elongated element. Furthermore, as the lifting jig picks up the façade lifting elongated element, the movable locking member automatically opens as the lifting jig contacts and displaces the movable locking member, while picking up the façade lifting elongated element.

An advantage is hence that horizontal transportation is safe, since a risk that the façade element accidentally falls off, such as if pushed off the suspendable conveyor trolley due to e.g. a collision, a sudden pull or push, or the like, is reduced or even eliminated.

Furthermore, another advantage is that the suspendable conveyor trolley is user-friendly, since an operator does not need to manually unlock the façade element when transferring the façade element from the horizontal transportation to e.g. vertical transportation, or vice versa. The operator can therefore without specialized training handle the façade elements, with the suspendable conveyor trolley ensuring safety.

A further advantage is that the movable locking member is reliable, since it includes only few parts, whose shapes are moreover robust and resistant to wear.

A still further advantage, also related to user-friendliness, is that the operator does not need to take any particular action to manually lock the façade element, since the movable locking member is biased towards the locking position.

As a result, safe and reliable transportation of the façade elements is ensured, in particular during horizontal transportation.

In some embodiments, the movable locking member is tiltable, or rotatable, in relation to the trolley elongated element. In this manner, the lifting jig is able to smoothly push the movable locking member away as it hooks into the façade lifting elongated element for lifting of the façade element.

In some embodiments, the movable locking member comprises a protrusion adapted to be contacted by the lifting jig. The protrusion is adapted to ensure proper abutment between the lifting jig and the movable lockable member such as to release the façade lifting elongated element.

In some embodiments, the trolley elongated element has an orifice through which the movable locking member extends. In this manner, space on a side of the trolley elongated element that faces the lifting jig is made available, i.e. is unoccupied, whereby the lifting jig may more easily access and engage with the façade lifting elongated element.

In some embodiments, the movable locking member is mechanically biased by means of a spring, such as a coil spring, helical spring or the like, that is arranged between the movable locking member and the trolley elongated element. When the spring is in an expanded state, the movable locking member is in the locking position. Consequently, when the spring is in a compressed state, the movable locking member is in an open position, such as a fully open position.

In some embodiments, the movable locking member and an attachment portion adapted to attach the movable locking member to the trolley elongated element have a respective excavated seat, preferably with a circular cross-section, adapted to receive the spring.

In some embodiments, the suspendable conveyor trolley comprises a conveying arrangement adapted to connect the trolley elongated element to and convey the trolley elongated element under the guide rail. Various known conveying arrangements for suspended conveyor trolleys may be used.

In some embodiments, the movable locking member is tiltable and/or rotatable in relation to the trolley elongated element about a rotation axis that is parallel to a longitudinal extension direction of the trolley elongated element.

In some embodiments, the trolley elongated element comprises a stop portion adapted to define a fully open position of the movable locking member, wherein when the movable locking member is forced against its bias, away from the locking position, the fully open position is reachable.

According to another aspect, this object is achieved by a system for horizontally conveying a façade element along a façade of a high-rise building. The system comprises a suspendable conveyor trolley according to embodiments herein and a lifting jig adapted to vertically guide the façade element along the façade. The lifting jig comprises a projecting portion adapted to contact and move the movable locking member of the suspendable conveyor trolley.

In some embodiments, the system comprises a façade lifting elongated element adapted to be attached to the façade element.

### BRIEF DESCRIPTION OF THE DRAWINGS

The various aspects of embodiments disclosed herein, including particular features and advantages thereof, will be readily understood from the following detailed description and the accompanying drawings, which are briefly described in the following.

FIG. 1 is an overview, illustrating a high-rise building at which façade elements are installed by means of the system and/or the suspendable conveyor trolley that are disclosed herein.

FIG. 2 is a plan view, schematically illustrating a façade element that has been horizontally conveyed and that is to be lifted by the lifting jig for vertical hoisting to a desired position.

FIG. 3 is a side view, illustrating an exemplifying suspendable conveyor trolley according to some embodiments herein.

FIG. 4 through FIG. 6 are side and plan views, illustrating the movable locking member and the attachment portion according to some embodiments herein.

FIG. 7a through FIG. 7f are side views, illustrating a transfer of a façade element from horizontal transportation to vertical transportation according to some embodiments herein.

FIG. 8 is a plan view, illustrating a portion of the trolley elongated element according to some embodiments herein.

FIG. 9 is a perspective view, illustrating an exemplifying lifting jig that may be used in combination with the suspendable conveyor trolley according to some embodiments herein.

FIG. 10 is a side view, illustrating the lifting jig according to FIG. 9.

### DETAILED DESCRIPTION

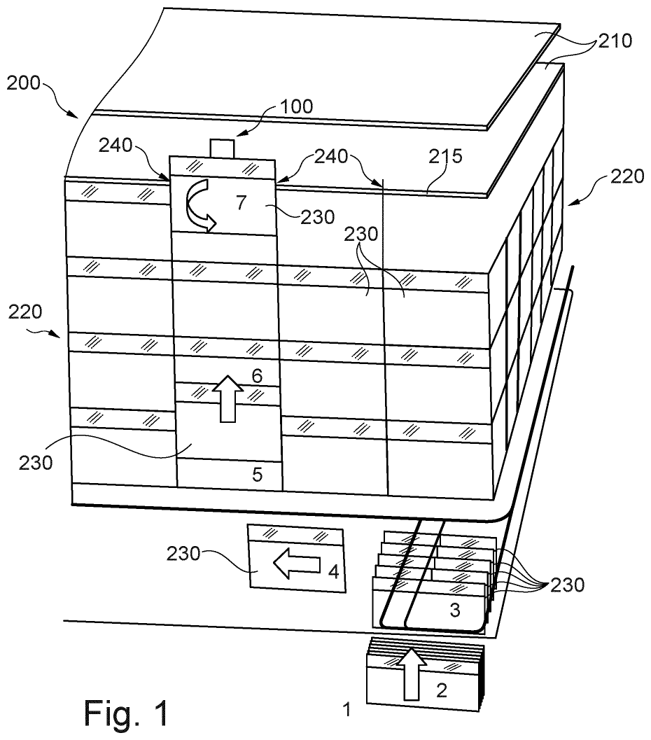

Throughout the following description, similar reference numerals have been used to denote similar features, such as legs, arms, parts, items, elements, units, steps or the like, when applicable. FIG. 1 is a schematic overview illustrating a high-rise building 200 in connection with which the embodiments herein may be applied. The high-rise building 200 has a plurality of floors 210, such as levels, floor levels, stories or the like. As shown in the figure, a façade 220 of the high-rise building 200 is at least partly covered with façade elements 230. A crane unit 100 for the installation of façade elements 230 is positioned on a floor 210 between two elongated mounting structures 240, such as wind posts or the like.

Installation of the façade elements 230 can be summarized as follows.
1. A truck (not shown) arrives at the construction site with a plurality of façade elements 230.
2. The façade elements 230 are vertically off-loaded from the truck. The façade elements 230 are connected to a horizontal guide rail.
3. The façade elements are put in a queue on the rail, ready to be horizontally transported before installation.
4. The façade element 230 is transported to a position, along the guide rail by means of a conveyor trolley (not shown), under the crane unit 100 that has been positioned between two elongated mounting structures 240 as mentioned above.
5. A wire (not shown) of the crane unit 100 is connected, such as indirectly connected via a lifting jig (not shown), to the façade element 230. In this step, the lifting jig lifts the façade element 230 from the conveyor trolley.
6. The crane unit 100 hoists the façade element 230 to the desired floor 210, while the façade element is guided by the elongated mounting structures 240.
7. Next, the façade element 230 is secured at its desired position at the façade 220 of the high-rise building 200.

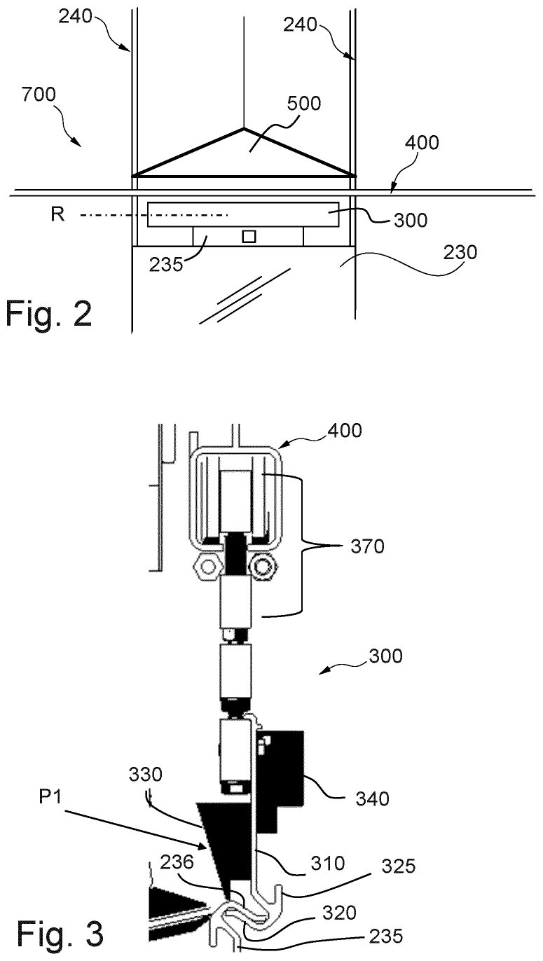

Now turning to FIG. 2, there is shown a schematic side view of a suspendable conveyor trolley 300 which has horizontally transported a façade element 230 to the position under the crane unit 100 (not shown). A schematically illustrated lifting jig 500 is lowered to lift the façade element 230 from the conveyor trolley 300 before the façade element 230 is hoisted to the desired position. Furthermore, FIG. 2 shows a façade lifting elongated element 235, such a strut with a certain profile. These kinds of struts, or beams, are often referred to as “profiles”, or metal extruded profiles. Accordingly, as used herein in, the term “elongated element” typically refers to a beam, a strut or the like. As an example, the elongated element may refer to a profile that is a profiled beam, which may have been extruded through a profile template to obtain a particular cross-sectional shape.

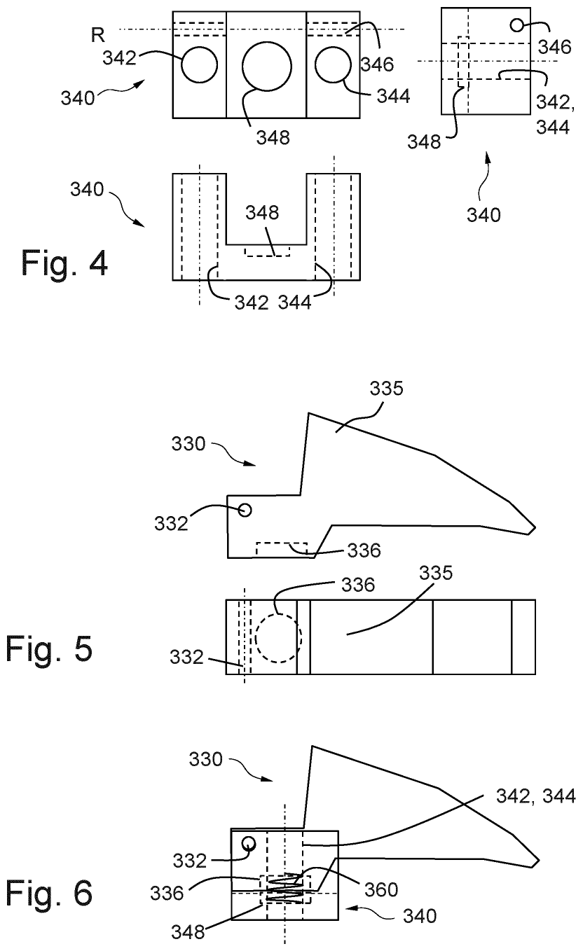

FIG. 3 illustrates an exemplifying suspendable conveyor trolley 300 for horizontally conveying the façade element 230 (not shown) along the façade 220 of the high-rise building 200 (not shown). In this example, the movable locking member 330 is tiltable and/or rotatable in relation to the trolley elongated element 310 about a rotation axis R that is parallel to a longitudinal extension direction of the trolley elongated element 310.

The suspendable conveyor trolley 300 is adapted to be suspended on a guide rail 400 that runs horizontally along the façade 220 (not shown).

The suspendable conveyor trolley 300 comprises a trolley elongated element 310 adapted to engage with a façade lifting elongated element 235 adapted to be attached to the façade element 230 (not shown), to carry and convey the façade element 230 along the façade.

The trolley elongated element 310 comprises a trolley hook portion 320, having a hook shaped cross-section and being adapted to receive and e.g. engage with a lifting hook portion 236 of the façade lifting elongated element 235.

Furthermore, the suspendable conveyor trolley 300 comprises a movable locking member 330 that is movably attached to the trolley elongated element 310 and mechanically biased towards a locking position P1, in which the trolley hook portion 320 is blocked by the movable locking member 330. The term “blocked” means hindering of unintended or undesired removal or release of the façade lifting element. Thus, by blocking the trolley hook portion 320, the lifting hook portion 236 is prevented from leaving the trolley hook portion 320 when the façade element 230 (not shown) is hanging in the trolley elongated element 310. This is shown in FIG. 3.

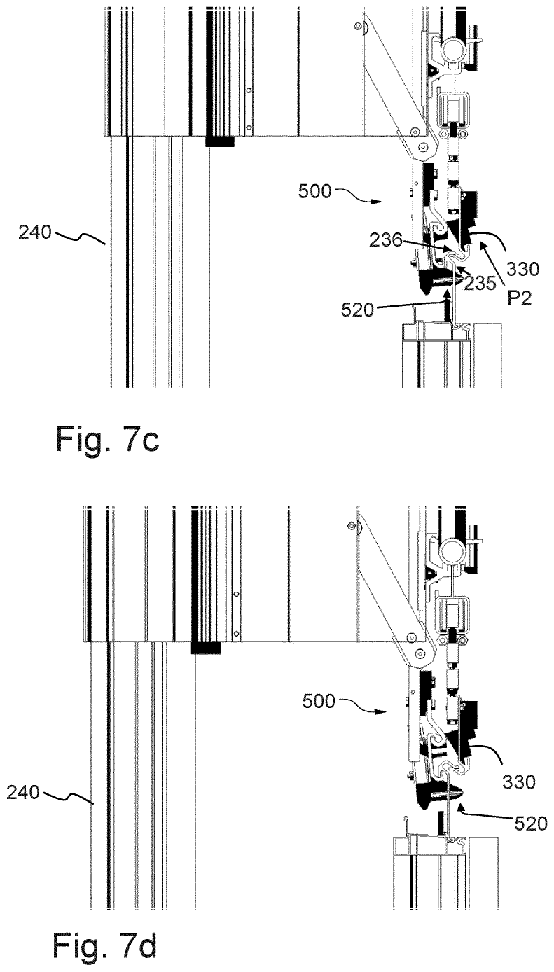

Moreover, the movable locking member 330 is adapted to be moved by applied direct pressure. Movement of the movable locking member 330 causes the unblocking of trolley hook portion 320, allowing lifting hook portion 236 to be removed from trolley hook portion 320. In particular, the movable locking member 330 is adapted to be moved by a lifting jig 500 away from the locking position P1 when the lifting jig 500 reaches and engages with the façade lifting elongated element 235, whereby the lifting hook portion 236 of the façade lifting elongated element 235 is capable of leaving the trolley hook portion 320. This is illustrated in FIGS. 7b-7e. This means that the façade lifting elongated element is releasable from the trolley hook portion 320 when the movable locking member 330 is moved sufficiently away from the locking position P1. In the locking position P1, the movable locking member 330 extends over a cavity formed by the trolley hook portion 320.

In order to allow the movable locking member 330 to be moved away from the locking position P1, the movable locking member 330 may be tiltable in relation to the trolley elongated element 310.

The suspendable conveyor trolley 300 may typically also comprise a conveying arrangement 370, such as wheels, fastening arrangements therefor and the like, adapted to connect the trolley elongated element 310 to and convey the trolley elongated element 310 under the guide rail 400.

The trolley elongated element 310 may also comprise a stop portion 325 adapted to define a fully open position P2 of the movable locking member 330, wherein when the movable locking member 330 is forced, e.g. by the lifting jig 500, against its bias away from the locking position P1 the fully open position P2 is reachable. The fully open position P2 is illustrated in FIG. 7c, wherein the movable locking member abuts to the stop portion 325 of the trolley elongated element 310. In this manner, the lifting jig 500 is guided to pick up the façade lifting elongated element 235 as understood from the sequence in FIGS. 7a-7f.

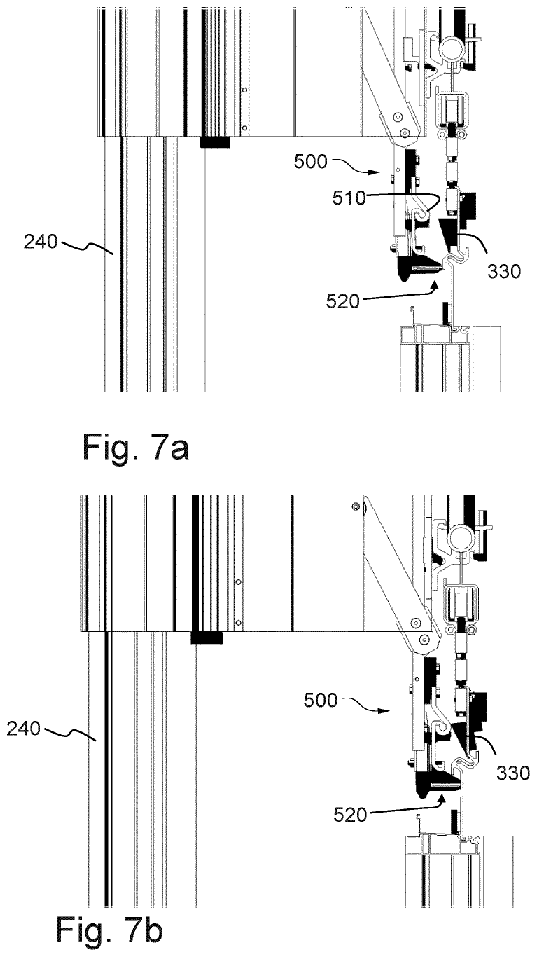

In FIG. 4 through FIG. 6, examples of an attachment portion 340 and the movable locking member 330 are illustrated, however, not to scale but merely schematically.

FIG. 4 shows the exemplifying attachment portion 340. For fastening of the attachment portion 340 to the trolley elongated element 310 (not shown), the attachment portion 340 may be provided with two holes 342, 344 in which two screws (not shown) may be mounted and screwed into the trolley elongated element 310.

Moreover, the attachment portion 340 may be provided with two rotation holes 346 in which the movable locking member 330 is movably, i.e. rotationally, connected. For this purpose, the movable locking member 330 has a hole 332 in which pins or screws (not shown) may be inserted through the hole 346. The movable member 330 may of course be rotationally connected in many different ways other than the one described here.

The attachment portion 340 may also be provided with a seat 348 as further described with reference to FIG. 6.

In some examples, as shown in FIG. 5, the movable locking member 330 comprises a protrusion 335 adapted to be contacted by the lifting jig 500 (not shown). Moreover, the movable locking member 330 may be provided with the hole 332 whereby it may cooperate with the holes 346 for being tiltably or rotationally connected to the attachment portion 340.

The movable locking member 330 may also be provided with a seat 336 as further described with reference to FIG. 6.

FIG. 6 shows the movable locking member 330 rotationally mounted in the attachment portion 340. In this example, the movable locking member 330 is mechanically biased by means of a spring 360 that is arranged between the movable locking member 330 and the trolley elongated element 310 (not shown in FIG. 6). The trolley elongated element 310 would be located below the attachment portion 340 if shown in FIG. 6.

Furthermore, the movable locking member 330 and the attachment portion 340, that is adapted to attach the movable locking member 330 to the trolley elongated element 310 (not shown), have a respective excavated seat 336, 348 adapted to receive the spring 360.

In FIG. 7a through FIG. 7f, a sequence of side views of the lifting jig 500 and the suspendable conveyor trolley 300 is shown. The sequence illustrates how the lifting jig 500 unlocks the façade element 230 from the conveyor trolley 300 and picks up the façade element 230 before hoisting (see below; compare FIGS. 2 and 3).

In FIG. 7a, the lifting jig 500 approaches the suspendable trolley, e.g. as it pivots out from the elongated mounting structures 240.

In FIG. 7b, the movable locking member 330 is contacted by the projecting portion 510 (not highlighted). Here, the movable locking member 330 commences an approach towards the fully open position P2, seen in FIG. 7c.

In FIG. 7c, the movable locking member 330 moves, e.g. rotates or tilts, due to the lifting jig 500, in particular the projecting portion thereof, to the fully open position P2. Fully open position P2 refers to the movable locking member 330 being displaced to such an extent that the façade lifting elongated element 235 may be released from the conveyor trolley 300, in particular from the lifting hook portion 320 thereof. The projecting portion 510 abuts and slides along the protrusion 335 of the movable locking member 330. At the same time, the lifting jig, i.e. a nose portion 520 thereof, enters an opening in the façade lifting elongated element. In this manner, centering of the façade element with respect to the lifting jig 500 is achieved.

In FIG. 7d, the lifting jig 500 has picked up the façade lifting elongated element from the suspendable conveyor trolley. The lifting jig 500 thus moves away from the suspendable conveyor trolley.

In FIG. 7e, the lifting jig 500 continues to move, by pivoting, the façade element towards the elongated mounting structures 240 in order for the façade element to eventually be hoisted to its desired position.

In FIG. 7f, it may be seen that the movable locking member 330 moves towards the locking position P1, due to its biasing, as the façade element is picked up and moved away.

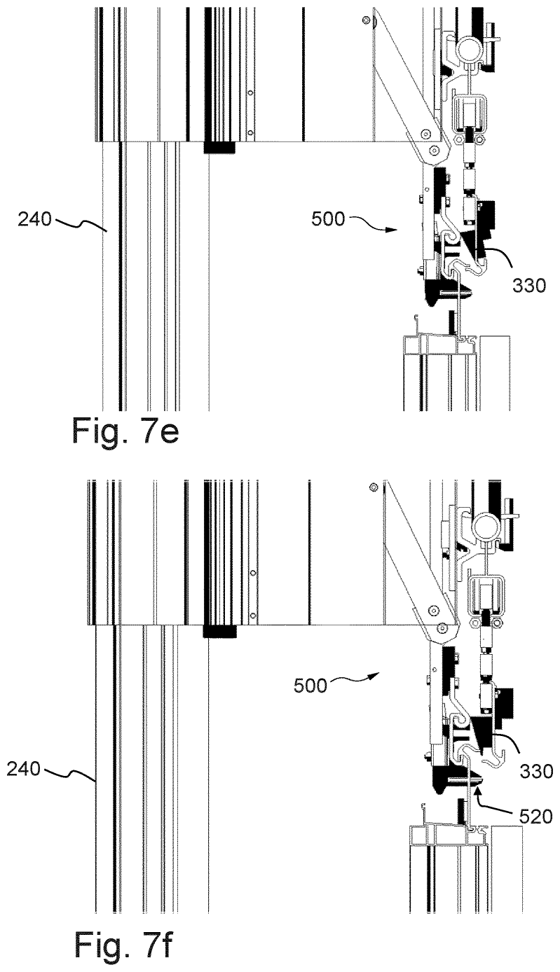

With reference to FIG. 8, the trolley elongated element 310 (not shown) may have an orifice 350 through which the movable locking member 330 (not shown) extends, e.g. when located in the locking position P1. For fastening of the attachment portion 340 (not shown), the trolley elongated element 310 may be provided with two attachment holes 352, 354.

Returning to FIG. 2, according to an aspect of the embodiments herein, there is illustrated a system 700 for horizontally conveying a façade element 230 along a façade of a high-rise building. The system 700 comprises a suspendable conveyor trolley 300 according to any embodiment disclosed herein and a lifting jig 500 as disclosed herein. The lifting jig 500 comprises the projecting portion 510 for abutment and movement of the movable locking member 330 of the suspendable conveyor trolley 300.

In some embodiments of the system, the system 700 further comprises a façade lifting elongated element 235 (not shown) adapted to be attached to the façade element 230.

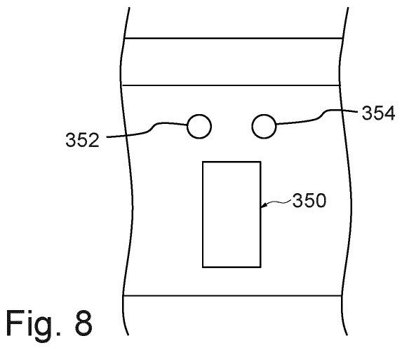

FIG. 9 shows a detailed partial perspective view of the lifting jig 500. The jig 500 comprises a horizontal base beam 22 to which a lifting rail 30 is attached. The lower edge of the lifting rail is hook-shaped, so that the lifting rail may engage with a façade element, e.g. via the façade lifting elongated element 235. A lifting frame 21 extends vertically from the base beam 22, in opposite direction from the lifting rail 30. In operation, the wire from the crane unit is attached to the top of the lifting frame 21 so that the entire lifting jig 500 is lifted in the lifting frame 21. The lifting frame 21 comprises two lifting beams 23, 24 which are attached to the base beam 22, on either side of the centre of the base beam 22. The two lifting beams 23, 24 are joined together over the center of the base beam 22 so that they form a triangular structure with the top point over the centre of the base beam. This allows for a simple and accurate centering of the lifting jig during hoisting. A further lifting beam 25 may be provided for strength. The lifting jig further comprises a linkage frame 90 which comprises vertical linkage rods 91, 92 which extend vertically from the base beam 22, on either side of the lifting beams 23, 24.

Moreover, the linkage rods 91, 92 are arranged essentially in parallel. A third linkage rod 93 extends horizontally between the parallel linkage rods 91, 92. The third, horizontal linkage rod 93 is rotationally attached into lockable torsion rod guides (not shown) in the upper ends of the parallel linkage rods 91, 92. The third horizontal linkage rod 93 provides for stability of the linkage frame 90. However, the third horizontal and rotational linkage rod 93 and the lockable torsion guides also allow for fine angular adjustments of the lifting yoke 20 (not shown). Pivot pins 94, 95, 96 and 97 for pivotal attachments to the arms of the linkage arrangement are provided in the upper and lower ends of the vertical linkage rods 91, 92.

The lifting jig 500 comprises a projecting portion 510. The movable locking member 330 (not shown) is adapted to be moved by the projecting portion 510 away from the locking position P1.

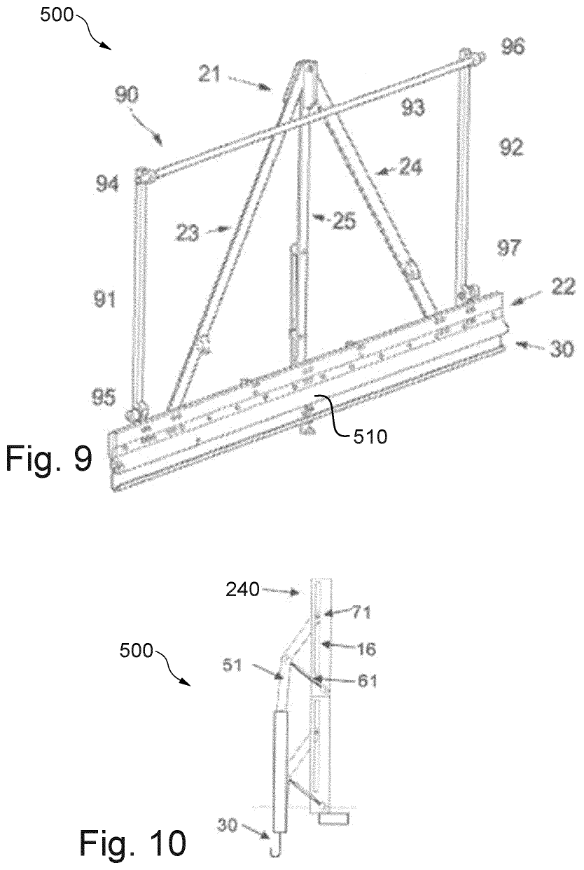

FIG. 10 is a side view of the lifting jig 500. The lifting jig 500 comprises pivot arms 51, push rods 61 and carriages 71; at least two of each, since there are two parallelly running elongated mounting structures 240. Thanks to the pivot arms 51 and push rods 61, the lifting jig is movable, whereby it can pick up the façade element (not shown in FIG. 10).

Even though embodiments of the various aspects have been described, many different alterations, modifications and the like thereof will become apparent for those skilled in the art. The described embodiments are therefore not intended to limit the scope of the present disclosure.

1. A system (700) for horizontally conveying a façade element (230) along a façade of a high-rise building (200), wherein the system (700) comprises a suspendable conveyor trolley (300) for horizontally conveying a façade element (230) along a façade of a high-rise building (200), wherein the suspendable conveyor trolley (300) is adapted to be suspended on a guide rail (400) that runs horizontally along the façade (220), wherein the suspendable conveyor trolley (300) comprises:
a trolley elongated element (310) adapted to engage with a façade lifting elongated element (235) adapted to be attached to the façade element (230), to carry and convey the façade element (230) along the façade, wherein the trolley elongated element (310) comprises a trolley hook portion (320), having a hook shaped cross-section and being adapted to receive a lifting hook portion (236) of the façade lifting elongated element (235); and
a movable locking member (330) that is movably attached to the trolley elongated element (310) and mechanically biased towards a locking position (P1), in which the trolley hook portion (320) is blocked by the movable locking member (330), wherein the movable locking member (330) is adapted to be moved by a lifting jig (500) away from the locking position (P1) when the lifting jig (500) reaches and engages with the façade lifting elongated element (235), and wherein the term “blocked” means hindering of unintended or undesired removal or release of the façade lifting element, specifically, by blocking the trolley hook portion (320), the lifting hook portion (236) is prevented from leaving the trolley hook portion (320) when the façade element (230) is hanging in the trolley elongated element (310); and
a lifting jig (500) adapted to vertically guide the façade element (230) along the façade, wherein the lifting jig (500) comprises a projecting portion (510) adapted to contact and move the movable locking member (330) of the suspendable conveyor trolley (300).

2. The system (700) according to claim 1, wherein the movable locking member (330) is tiltable in relation to the trolley elongated element (310).

3. The system (700) according to claim 1, wherein the movable locking member (330) comprises a protrusion (335) adapted to be contacted by the lifting jig (500).

4. The system (700) according to claim 1 wherein the trolley elongated element (310) has an orifice (350) through which the movable locking member (330) extends.

5. The system (700) according to claim 1, wherein the movable locking member (330) is mechanically biased by means of a spring (360) that is arranged between the movable locking member (330) and the trolley elongated element (310).

6. The system (700) according to claim 1, wherein the movable locking member (330) and an attachment portion (340) adapted to attach the movable locking member (330) to the trolley elongated element (310) have a respective excavated seat (336, 348) adapted to receive the spring (360).

7. The system (700) according to claim 1, wherein the suspendable conveyor trolley (300) comprises a conveying arrangement (370) adapted to connect the trolley elongated element (310) to, and convey, the trolley elongated element (310) under the guide rail (400).

8. The system (700) according to claim 1, wherein the movable locking member (330) is tiltable and/or rotatable in relation to the trolley elongated element (310) about a rotation axis (R) that is parallel to a longitudinal extension direction of the trolley elongated element (310).

9. The system (700) according to claim 1, wherein the trolley elongated element (310) comprises a stop portion (325) adapted to define a fully open position (P2) of the movable locking member (330), wherein when the movable locking member (330) is forced against its bias away from the locking position (P1) the fully open position (P2) is reachable.

10. The system (700) according to claim 1, wherein the system (700) further comprises a façade lifting elongated element (235) adapted to be attached to the façade element (230).
